(19) United States
(12) Patent Application Publication
(10) Pub. No.: US 2015/0046366 A1
(43) Pub. Date: Feb. 12, 2015

(54) Method And System For Batch Generation Of Reports

(71) Applicant: Lingua Next Technologies Pvt. Ltd, Pune (IN)

(72) Inventor: Rajeevlochan Phadke, Pune (IN)

(73) Assignee: Lingua Next Technologies Pvt. Ltd, Pune (IN)

(21) Appl. No.: 13/963,362

(22) Filed: Aug. 9, 2013

(51) Int. Cl. G06Q 10/10; G06F 17/28

(52) U.S. Cl. CPC G06Q 10/10; G06F 17/28
USPC 705/342

(57) ABSTRACT

A method and system for batch generation of one or more monolingual reports or bilingual reports is disclosed. One or more report types and a pre-stored data file are selected by a user. Customers account information is retrieved from the pre-stored data file. One or more report templates are verified based on the type of report and the report language. The one or more monolingual or bilingual reports are generated for the verified report template using the customers account information.

### COPYRIGHT NOTICE

A portion of the disclosure of this patent document contains material that is subject to copyright protection. The copyright owner has no objection to facsimile reproduction of any one of the patent documents, or the patent disclosure, as it appears in the Patent and Trademark Office patent file or records. Otherwise all copyright rights are reserved.

### TECHNICAL FIELD

The presently disclosed embodiments are related to generation of documents. More particularly, the presently disclosed embodiments are related to batch generation of documents.

### BACKGROUND

Owing to growth in digitization of documents, most corporations maintain documents in electronic format for easy processing. For generating bulk reports having similar templates, various batch processing tools are available in the market these days. In general, standard templates are used while generating reports using such tools. However, the main problem plaguing bulk generation of reports is the issue of formatting of the documents. The situation deteriorates further when the reports which need to be generated are of multiple types. For instance, one organization may provide varied services for which multiple documents need to be maintained. Bulk processing of these documents becomes a concern for companies which have to regularly share various documents with clients, for example, companies in banking and insurance sectors. In such a case, the manual intervention required for formatting these client reports is immense.

### SUMMARY

According to embodiments illustrated herein, there is provided a method implemented on a computing system for batch generation of a monolingual report or a bilingual report. The method includes selecting one or more report types and a pre-stored data file. The pre-stored data file includes one or more customers account information. Further, the method includes accessing one or more report templates. The one or more report templates are then verified based on the one or more report types and a report language. The report language is retrieved from the one or more customers account information. Thereafter, at least one of the one or more monolingual reports or the one or more bilingual reports are generated based on the verified one or more report templates and the one or more customers account information.

According to embodiments illustrated herein, there is provided a system for batch generation of a monolingual report or a bilingual report. The system includes a memory including one or more program instruction modules. The one or more program instruction modules include an input module, a report verifying module and a report generating module. The input module is configured for receiving one or more report types and a pre-stored data file. The pre-stored data file includes one or more customers account information. The report verifying module access one or more report templates. The report verifying module is further configured for verifying a match for the one or more report templates based on at least one of the one or more report types and a report language, the report language being retrieved from the one or more customers account information. The report generation module is configured for generating at least one of the one or more monolingual reports or the one or more bilingual reports based on the verified one or more report templates and the one or more customers account information.

According to embodiments illustrated herein, there is provided a computer program product for use with a computer. The computer program product includes a non-transitory computer readable medium. The non-transitory computer readable medium stores a computer program code for batch generation of a monolingual report or a bilingual report. The computer program code is executable by one or more processors to receive one or more report types and a pre-stored data file. The pre-stored data file includes one or more customers account information. The one or more processors access one or more report templates. A match is verified for the one or more report templates based on at least one of the one or more report types and a report language. The report language is retrieved from the one or more customers account information. The one or more monolingual reports or the one or more bilingual reports are generated based on the verified one or more report templates and the one or more customers account information.

### BRIEF DESCRIPTION OF DRAWINGS

The accompanying drawings illustrate various embodiments of systems, methods, and embodiments of various aspects of the invention. Any person having ordinary skills in the art will appreciate that the illustrated element boundaries (e.g., boxes, groups of boxes, or other shapes) in the Figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 illustrates an environment in which the presently disclosed embodiments can be implemented;

FIG. 2 is a block diagram illustrating a computing system in accordance with at least one embodiment;

FIG. 3 depicts a template of a pre-stored data file in accordance with at least one embodiment;

FIG. 4 depicts an exemplary sample of a report template in accordance with at least one embodiment;

FIG. 5 is a flow diagram illustrating a method for batch generation of a monolingual report or a bilingual report in accordance with at least one embodiment;

FIGS. 6A and 6B are flow diagrams illustrating a method for batch generation of a monolingual report or a bilingual report in accordance with at least one embodiment; and

FIG. 7 depicts a bilingual report in accordance with at least one embodiment.

### DETAILED DESCRIPTION

The present disclosure is best understood with reference to the detailed Figures and description set forth herein. Various embodiments are discussed below with reference to the Figures. However, those skilled in the art will readily appreciate that the detailed descriptions given herein with respect to the Figures are simply for explanatory purposes as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### DEFINITIONS

“Report Type” refers to the type of report which needs to be generated by a user. For example, when the user is an insurance company, then the report type may refer to Premium Due date notice, Policy Lapse Notice and the like.

“Report Template” refers to a pre-defined format of the report type, for example, different formats for policies started in different years.

“Pre-stored Data File” refers to a customer profile data in which collective information related to the customers are present. A single Pre-stored data file may include information about all the customers, or multiple pre-stored data files may be utilized for storing information about all the customers. For instance, in case of an insurance company, the insurance company will maintain a data file corresponding to a profile data and an account data for each of its customers having data fields such as name, policy number, and the like.

“Customer account information” refers to the data stored in the pre-stored data file corresponding to each of the customers for which the reports need to be generated.

“Monolingual Reports” refers to reports which include text in a single language.

“Bilingual Reports” refers to reports which include text in two languages. For instance, the report may contain some text in a first language while some text may be in a different language.

“Fixed Text” refers to the text in the report which remains the same for each report and is predefined.

“Variable Text” refers to text in the report which can be changed for each report and may be filled as variable data. For instance, variable text in a report may refer to the fields which are required to be filled using customer/user specific information.

The present disclosure describes a system and a method for batch generation of monolingual or bilingual reports. The system is configured to receive a report type and a pre-stored data file from a user. The system further retrieves one or more customers account information from the pre-stored data file. Based on the selected report type and a report language retrieved from the customer account information, the system access and verifies a report template. The system is configured to ask the user to mark one or more areas on the report template for performing a formatting action on the marked areas. Monolingual and/or bilingual reports are generated using the verified report template and the one or more customers account information.

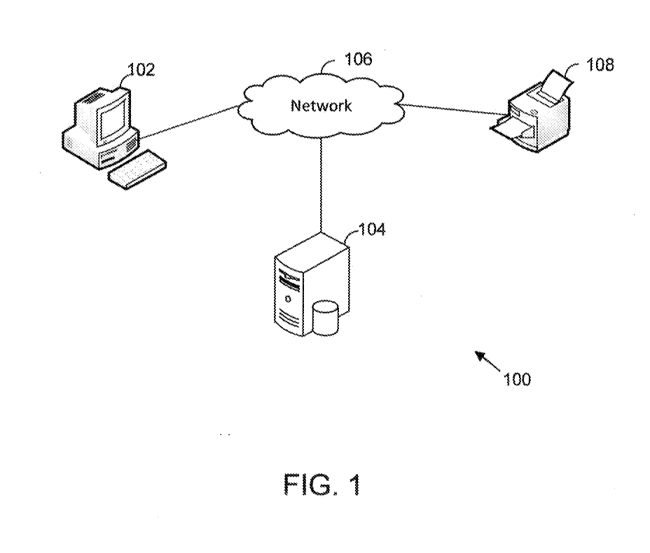

FIG. 1 illustrates an environment 100, in which the presently disclosed embodiments can be implemented. The environment 100 includes a computing system 102, an application server 104, a network 106 and a printing system 108.

The computing system 102 may be any electronic device possessing processing capabilities for executing a set of instructions. The computing system 102 may further be capable of providing a user interface to a user. The computing system 102 may be any known electronic device, such as, but not limited to, computer, laptop, PDA, phone, and other similar devices. The computing system 102 is capable of executing the application for batch generation of monolingual and bilingual reports.

The application server 104 may be any electronic device capable of performing computation, including at least one database and at least one processor. The application server 104 may further be capable of storing and executing the application for batch generation of monolingual and/or bilingual reports.

The network 106 refers to a medium for interconnecting more than one electronic device. The network 106 may include local area network (LAN), wide area network (WAN), metropolitan area network (MAN) and the internet. Further, the network 106 may utilize various communication protocols e.g. transmission control protocol (TCP), user datagram protocol (UDP), Bluetooth, IEEE 802.11, Wi-Fi, Infra-red and the like. The network 106 may further include, but is not limited to interconnecting multiple electronic devices using a wired connection.

The printing system 108 may be capable of printing the one or more monolingual or bilingual reports. The printing system 108 may include, but is not limited to, a Multifunction Device (MFD) or a printer.

The computing system 102, application server 104 and the printing system 108 may be connected to each other through the network 106. The computing system 102 may execute an application for batch generation of monolingual and bilingual reports. The application for batch generation of monolingual and bilingual report may require an input provided by the user.

In an alternate embodiment, the user may access the application for batch generation of monolingual and bilingual reports executed by the application server 104 through the computing system 102. The application server 104 may be communicably coupled to the computing system 102 through the network 106. The input provided by the user at the computing system 102 may be transmitted to the application server 104 through the network 106.

In an embodiment, the printing system 108 may further be communicably coupled to the computing system 102 and/or to the application server 104, through the network 106.

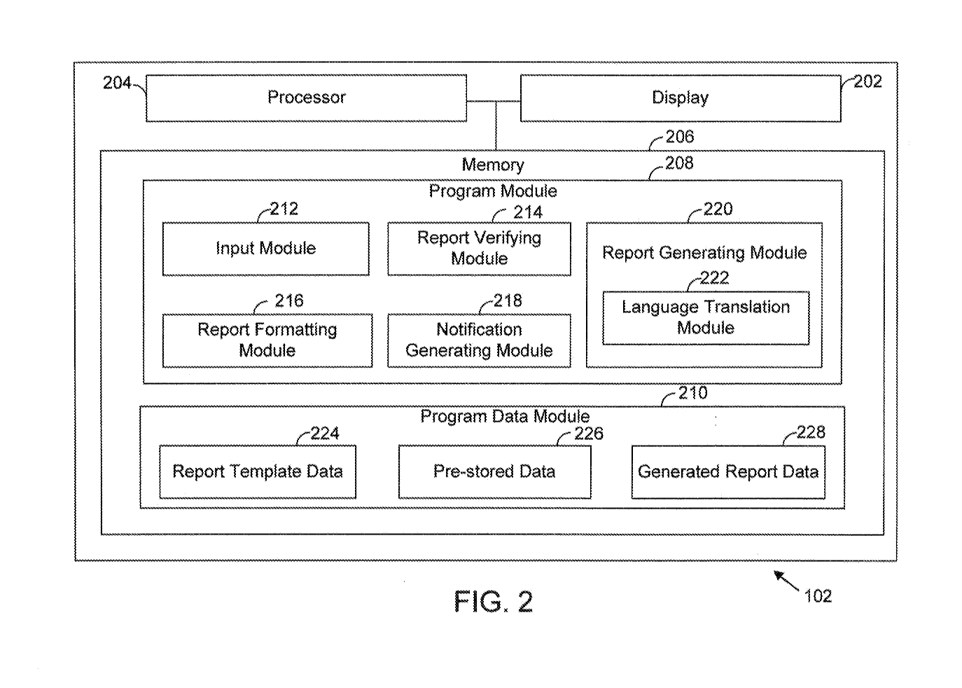

FIG. 2 is a block diagram illustrating the computing system 102 in accordance with at least one embodiment.

In an embodiment, the computing system 102 includes a display 202, a processor 204 and a memory 206. The display 202 is used to provide a user interface to the user. The processor 204 is connected to the display 202 and the memory 206. The memory 206 further includes a program module 208 to store a set of instructions (shown as various modules) and a program data module 210 to store a set of data which may be required to execute the stored set of instructions.

The processor 204 is capable of executing the set of instructions (modules) which are stored in the program module 208 and accessing the set of data from the program data module 210 for the execution of the set of instructions.

The program module 208 includes an input module 212, a report verifying module 214, a report formatting module 216, a notification generating module 218, and a report generating module 220. The report generating module 220 further includes a language translation module 222.

The program data module 210 includes a report template data 224, a pre-stored data 226, and a generated report data 228.

The display 202 may include any known display device, such as, but not limited to, Light Emitting Display (LED), Organic Light Emitting Display (OLED), Liquid Crystal Display (LCD), and other similar technologies. The display 202 may be externally connected to the computing system 102, or in another embodiment the display 202 may be embedded in the computing system 102.

The processor 204 can be any known processing device, for example, but not limited to, single core processors, dual core processors, ARM processors, Cortex processors, Vertex processor or other processors with similar capabilities. The processor 204 is configured to process the set of instructions stored in the memory 206.

The memory 206 is connected to the processor 204. The memory 206 may be an internal memory like Static Random Access Memory (SRAM), Dynamic Random Access Memory (DRAM), Read Only Memory (ROM), Flash memory or other similar storage devices. Alternatively the memory 206 may be an external memory connected to the computing system 102. Some examples of such memory 206, may be Universal Serial Bus (USB) drives, hard disks, floppy disks, Compact Disk (CD) or any known similar external storage device.

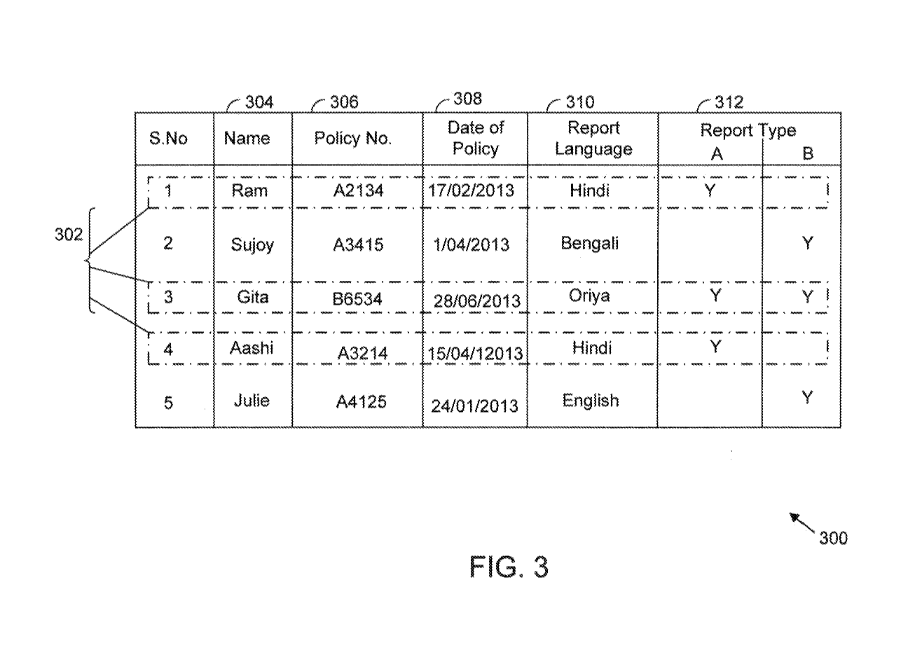

The input module 212 receives one or more report types 312 (described in detail in conjunction with FIG. 3), and a pre-stored data file 300 provided by the user. The input module 212 may retrieve one or more customers account information 302 from the pre-stored data file 300.

For the purpose of batch generation of monolingual and/or bilingual reports, the one or more report types 312 and the pre-stored data file 300 are selected by the user using the user interface provided by the display 202. The pre-stored data file 300 and the one or more report types 312 are described in conjunction with FIG. 3.

FIG. 3 depicts a template of the pre-stored data file 300 in accordance with at least one embodiment.

The pre-stored data file 300 may be created and modified by the user for a plurality of customers. In an alternate embodiment the pre-stored data file 300 may be created by a third party and supplied to the user.

The pre-stored data file 300 includes the one or more customers account information 302 for preferably each of a plurality of customers. The one or more customers account information 302 may further include information related to preferably each of the plurality of customers for which the selected report type 312 is required to be generated.

The customers account information 302 may include the report language 310 and the one or more report types 312, and may further include, but is not limited to, a name 304, a policy number 306 and a date of policy 308.

The report language 310 refers to a language of the output report required by the plurality of customers. The report language 310 may refer to any language, for example, but not limited to, English, Hindi, Oriya and Bengali. In case the report language 310 is not available in the pre-stored data file 300 for any of the plurality of customers, the report generating module 220 may generate the one or more monolingual or bilingual reports in a default reporting language. The default report language may be provided by the user.

The one or more report types 312 refer to the type of reports which need to be generated in a monolingual or bilingual format for preferably each of the plurality of customers. For instance, a few of the plurality of customers may require a report type A which may correspond to the Premium Due date notice while others may require a report type B which may correspond to the Policy Lapse Notice. The data in the report type 312 column indicates a selection of the report type to be generated against each of the customer. For example, the data may include “Y”, “Yes” or any other text or symbol indicative of the selection.

For instance, referring to FIG. 3, for the first customer (“Ram”), the data indicates a Y under the report type 312 “A” which means that the report type 312 “A” is selected to be generated for the first user. Similarly, referring to the second customer (“Sujoy”) the data indicates a Y under the report type 312 “B” which means that the report type 312 “B” is selected to be generated for the second user.

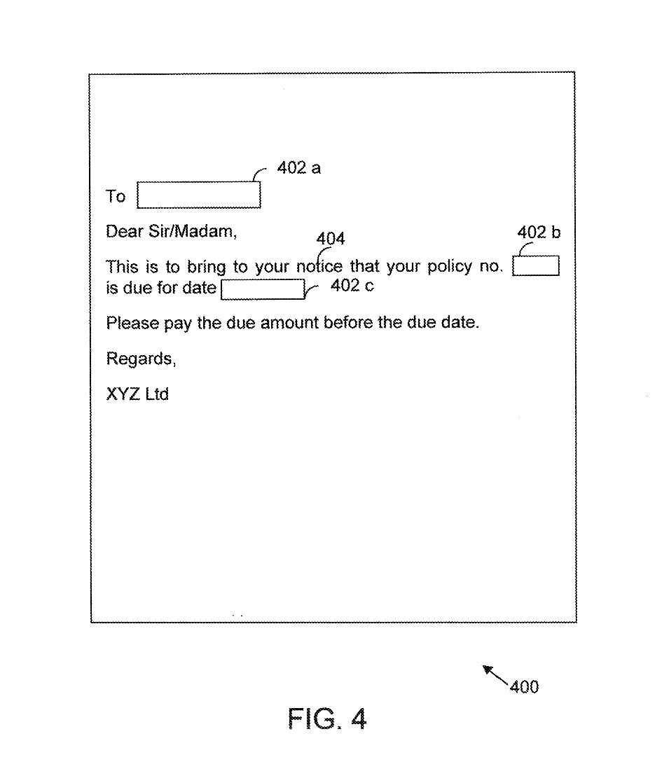

Upon receipt of the one or more report types 312 and the customer account information 302 from the input module 212, the report verifying module 214 accesses a report template 400 from the report template data 224. The report template 400 is explained in conjunction with FIG. 4.

FIG. 4 depicts an exemplary sample of the report template 400 in accordance with at least one embodiment;

The one or more report templates 400 include one or more place holders 402a, 402b and 402c (hereinafter collectively referred to as place holders 402) for a variable text, and a fixed text 404. The one or more report templates 400 may be created by the user. The report template 400 may be created by using any word application including, but not limited to, MS Word.

The one or more place holders 402 for the variable text are populated using the customer account information 302.

In an example, in case the report type 312 refers to “A” which may correspond to the Premium Due date notice, then the report template 400 for the report type 312 may be available in multiple versions and languages depending on the year of start of the insurance policy.

In an alternate embodiment, the one or more report templates 400 may be provided to the user by a template provider. The template provider here may refer to an organization which creates the report template 400 in one or more languages or may provide the translation for the one or more languages required for the one or more report templates 400.

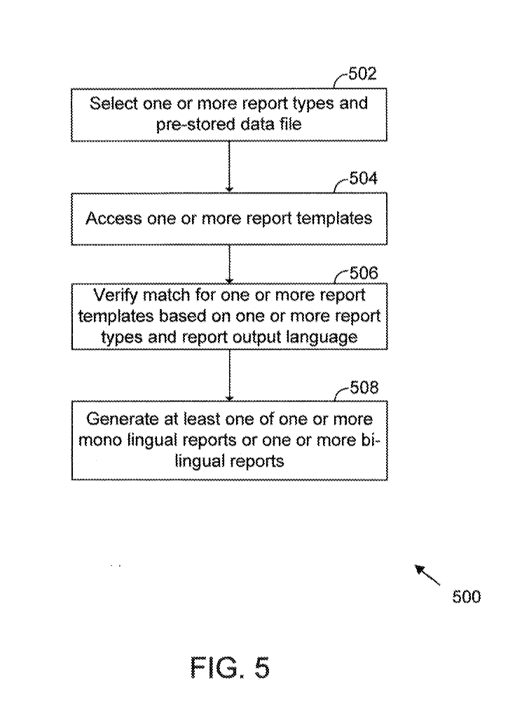

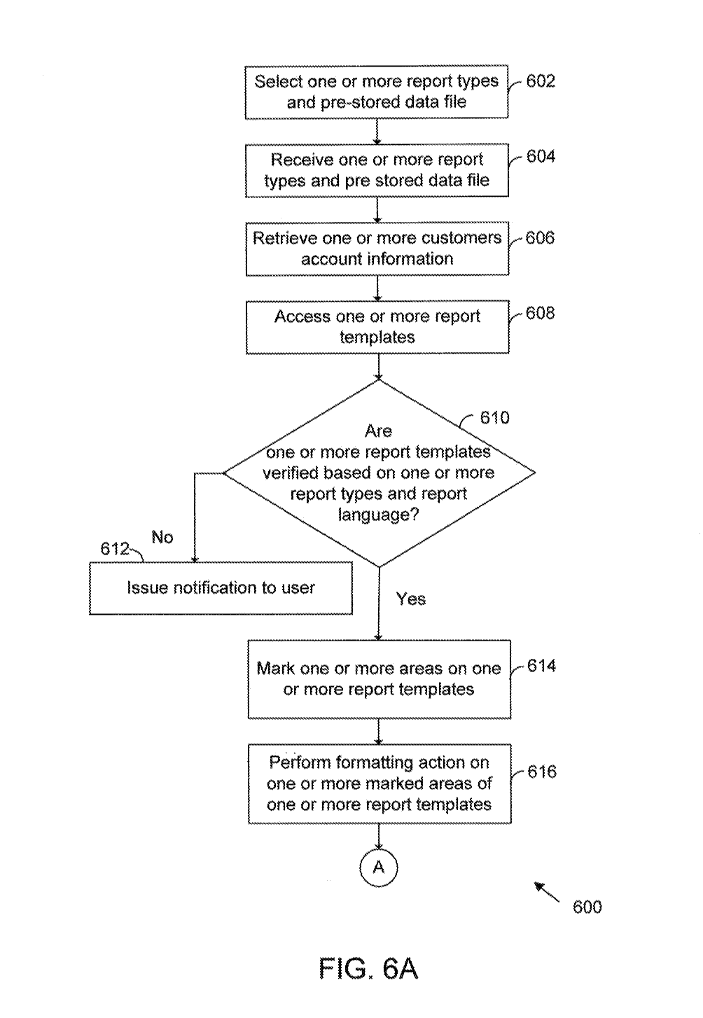

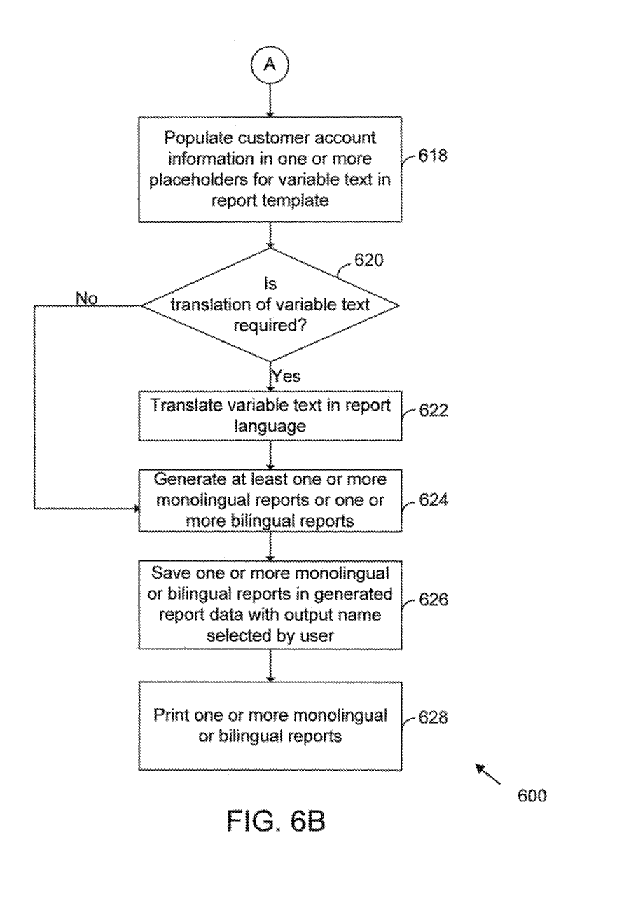

The report verifying module 214 further verifies a match (explained in detail with respect to FIG. 5 and FIGS. 6A and 6B) for the report template 400 on the basis of the one or more report types 312 and a report language 310. The report verifying module 214 provides the verified report template 400 to the report formatting module 216.

The report formatting module 216 asks the user to mark one or more areas on the report templates 400. The report formatting module 216 may further perform a formatting action on the one or more marked areas on the report template 400. The formatting action may include, but is not limited to, deleting the one or more marked areas such that the deleted one or more marked areas are not printed in the generated monolingual or bilingual report, or performing a rich text formatting on the one or more marked areas. The rich text formatting may include, but is not limited to, highlighting characters in the one or more marked areas, editing font type, font size of the characters in the one or more marked areas, making characters in the one or more marked areas bold, italicizing the one or more marked areas, underlining the one or more marked areas, and inserting images in the one or more marked areas.

The report generating module 220 receives the one or more report templates 400 from the report formatting module 216. The report generating module 220 may generate the one or more monolingual or bilingual reports for preferably each of the plurality of customers by populating the one or more customers account information 302 from the pre-stored data file 300 into the one or more report templates 400. The language translation module 222 may translate the populated customer account information 302 into the report language 310. The language translation module 222 may utilize a phonetic translation or a language dictionary look-up for translating the customer account information 302.

The notification generating module 218 may notify the user of an error. The error may include, but is not limited to, non availability of the one or more report templates 400 in the report language 310 for the report type 312 selected.

The pre-stored data 226 may store a plurality of the pre-stored data files 300. The report template data 224 may store the one or more report templates 400. The generated report data 228 may store the monolingual and/or bilingual reports generated by the report generating module 220.

FIG. 5 is a flow diagram 500 illustrating a method for batch generation of a monolingual report or a bilingual report in accordance with at least one embodiment.

At step 502, the user may select the one or more report types 312 and the pre-stored data file 300 using the user interface provided on the display 202. At step 504, the report verifying module 214 may access the report template 400 from the report template data 224 in the program data module 210. At step 506, the report verifying module 214 performs verification for the report template 400 accessed. The verification is done based on the one or more report types 312 and the report language 310

At step 508, the report generating module 220 generates the one or more monolingual or bilingual reports based on the report template 400 and the one or more customers account information 302.

FIGS. 6A and 6B are flow diagrams 600 illustrating a method for batch generation of a monolingual report or a bilingual report in accordance with at least one embodiment

At step 602, the user may select the one or more report types 312 and the pre-stored data file 300 using the user interface. At step 604, the input module 212 receives the selected one or more report types 312 and the selected pre-stored data file 300. At step 606, the input module 212 may retrieve the one or more customers account information 302 from the selected pre-stored data file 300. The retrieved customer account information 302 may include the report language 310 along with the report type 312, the name 304, the policy no 306 and the date of policy 308.

At step 608, the report verifying module 214 may access the report template 400 from the report template data 224. The report template 400 is accessed based on the report type 312 and the report language 310. At step 610, the report verifying module 214 verifies the match for the report template 400. The verification step may include, but is not limited to, a check for an availability of the report template 400 in the report language 310 for the one or more report types 312. The verifying step may further include a check for the one or more place holders 402 available in the report template 400 and the customer account information available in the pre-stored data file 300 required for the one or more report types 312 selected by the user. The verification step may further include a check to validate whether the variable text required for the place holders 402 of the report template 400 is available in the customers account information 302 of the pre-stored data file 300.

In case the report template 400 is not verified at step 610, the notification generating module 218 will issue a notification for error at step 612. The notification may include a pop up message, a warning message or other similar means to notify the user of the report template 400 not being verified.

In the event the report template 400 gets verified, at step 614, the report formatting module 216 may ask the user to mark the one or more areas on the report template 400. At step 616, the report formatting module 216 performs the formatting action on the marked one or more areas. The formatting action may include, but is not limited to, deleting the one or more marked areas so that the deleted one or more marked areas are not printed in the generated monolingual or bilingual report, or performing a rich text formatting on the one or more marked areas.

At step 618, the report generating module 220 may populate the customer account information 302 from the pre-stored data file 300 into the one or more place holders 402 for the variable text in the formatted report template 400. For instance, for report type A, the customer account information 302 may include any one of the fields such as the name 304 “Ram”, the policy no. 306 “A2134” and the date of policy 308 “17 Feb. 2013”. Hence the one or more place holders 402a, 402b and 402c may be populated by “Ram”, “A2134” and “17 Feb. 2013” respectively.

At step 620, in case the translation of the customer account information 302 is not required, the report generating module 220 generates the one or more bilingual reports at step 624.

At step 620, in case the translation of the populated customer account information 302 is required, then at step 622, the language translation module 222 translates the populated customer account information 302 into the report language 310. The language translation module 222 may utilize, but is not limited to, the phonetic translation or the language dictionary look-up for translating the populated customer account information 302. After the translation of the populated customer account information 302, the report generating module 220 generates the one or more monolingual reports at step 624.

At step 626, the report generating module 220 may store the generated one or more monolingual or bilingual reports in the generated report data 228. The generated one or more monolingual or bilingual reports may be stored at step 626, by an output file name selected by the user.

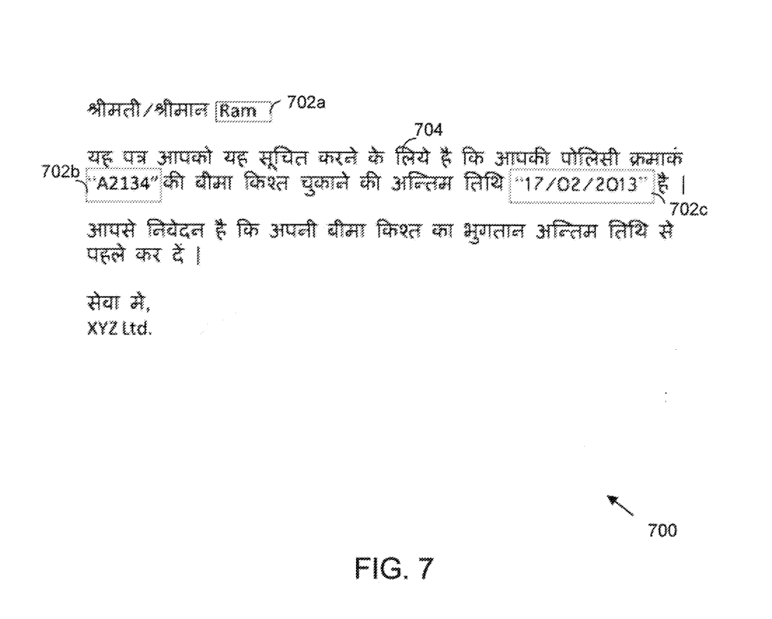

At step 628 the generated one or more monolingual or bilingual reports may be accessed by the processor 204 to enable the set of instructions required for printing of the generated one or more monolingual or bilingual reports. The set of instructions required for printing of the generated one or more monolingual or bilingual reports may be received by the printing system 108 for printing the one or more monolingual or bilingual reports. The exemplary sample of the generated bilingual report is explained in conjunction with FIG. 7.

FIG. 7 depicts a bilingual report 700 in accordance with at least one embodiment.

The bilingual report 700 is generated based on the method steps explained in FIGS. 6A and 6B. For instance, the user has selected the one or more report types 312 to be “A” and the pre-stored data file 300 using the display 202 of the computing system 102. The input module 212 retrieves the customer account information 302. The report language 310 retrieved from the customer account information 302 for the customer “Ram” is “hindi. So, the report verifying module 214 will access the report template 400 in Hindi for the report type 312 “A” from the report template data 224.

The report generating module 220 populates the place holder 402a with “Ram”, the place holder 402b with “A2134”, and the place holder 402c with “17 Feb. 2013” (referred in FIG. 7 as 702 a, 702b and 702c). The fixed text 404 is referred to as 704 in FIG. 7.

Thus the bilingual report 700 may be sent to the printing system 108 for printing.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, and a display unit. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through an input device, accessible to the system through an I/O interface.

The computer system executes a set of instructions that are stored in one or more storage elements in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, DOS', ‘Android’, ‘Symbian’, and ‘Linux’.

The programmable instructions can be stored and transmitted on a non-transitory computer-readable medium. The disclosure can also be embodied in a computer program product comprising a non-transitory computer-readable medium, or with any product capable of implementing the above methods and systems, or the numerous possible variations thereof.

The method, system, and computer program product, as described above, have numerous advantages. Some of these advantages may include, but are not limited to, performing batch generation of multiple monolingual reports and multiple bilingual reports for multiple report templates with minimal user intervention. The above described method and system allows the user to format the generated monolingual reports and bilingual reports as per its requirements and enable the user to predefine the required format at the same time for multiple reports. The above described method and system further allows the user to control the versioning of the report types and the report templates. The user may define a new report type, provide language options, define output file naming convention, and carry out validation across templates of various languages (of a given report type).

Various embodiments of the Method and System for Batch Generation of Reports have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for batch generation of a monolingual report or a bilingual report, the method comprising:
selecting one or more report types and a pre-stored data file, wherein the pre-stored data file comprises one or more customers account information;
accessing one or more report templates;
verifying a match for the one or more report templates based on at least one of the one or more report types and a report language, wherein the report language is retrieved from the one or more customers account information; and
generating at least one of the one or more monolingual reports or the one or more bilingual reports based on the verified one or more report templates and the one or more customers account information, wherein the above steps are performed by a processor.

2. The method of claim 1, wherein the pre-stored data file comprises the one or more customers account information for a plurality of customers.

3. The method of claim 1, wherein the one or more customers account information comprises information about at least one of names of the plurality of customers, the one or more report types required by the plurality of customers, and the report language provided by the plurality of customers.

4. The method of claim 1, wherein the one or more report templates comprise a fixed text and one or more place holders for a variable text.

5. The method of claim 4 further comprising populating the one or more customers account information in the one or more place holders for the variable text.

6. The method of claim 5 further comprising translating the populated customers account information in the report language based on at least one of a phonetic translation and a language dictionary look-up.

7. The method of claim 1 further comprising marking one or more areas on the verified report template.

8. The method of claim 7 further comprising performing a formatting action on the one or more marked areas.

9. The method of claim 1 further comprising issuing one or more notification for one or more errors.

10. A system for batch generation of a monolingual report or a bilingual report, the system comprising:
a memory comprising one or more program instruction modules, the one or more program instruction modules comprising:
an input module configured for receiving one or more report types and a pre-stored data file, wherein the pre-stored data file comprises one or more customers account information,
a report verifying module configured for:
accessing one or more report templates; and
verifying a match for the one or more report templates based on at least one of the one or more report types and a report language, wherein the report language is retrieved from the one or more customers account information, and
a report generating module configured for generating at least one of the one or more monolingual reports or the one or more bilingual reports based on the verified one or more report templates and the one or more customers account information; and
a processor operable to execute the one or more program instruction modules.

11. The system of claim 10, wherein the input module is further configured for retrieving the one or more customers account information from the pre-stored data file.

12. The system of claim 10, wherein the pre-stored data file comprises the one or more customers account information for a plurality of customers.

13. The system of claim 10, wherein the one or more customers account information comprises information about at least one of names of the plurality of customers, the one or more report types required by the plurality of customers, and the report language provided by the plurality of customer.

14. The system of claim 10, wherein the report generating module is further configured for populating the one or more customers account information into one or more place holders for one or more variable text in the one or more report templates.

15. The system of claim 10, wherein the report generating module further comprising a language translation module configured for translating the populated one or more customers account information in the report language based on at least one of a phonetic translation and a language dictionary look-up.

16. The system of claim 10 further, wherein the memory further comprises a notification generating module configured for generating a notification for one or more errors.

17. The system of claim 10, wherein the memory further comprises a report formatting module configured for marking one or more areas of the one or more report templates.

18. The system of claim 17, wherein the report formatting module is further configured for performing a formatting action on the one or more marked areas.

19. A computer program product for use with a computer, the computer program product comprising a non-transitory computer readable medium, wherein the non-transitory computer readable medium stores a computer program code for batch generation of a monolingual report or a bilingual report, the computer program code being executable by one or more processors to:
receive one or more report types and a pre-stored data file, wherein the pre-stored data file comprises one or more customers account information;
access one or more report templates;
verify a match for the one or more report templates based on at least one of the one or more report types and a report language, wherein the report language is retrieved from the one or more customers account information; and
generate at least one of the one or more monolingual reports or the one or more bilingual reports based on the verified one or more report templates and the one or more customers account information.
